(19) United States
(12) Patent Application Publication
(10) Pub. No.: US 2023/0147062 A1
(43) Pub. Date: May 11, 2023

(54) Pulse Detonation Wave Generator

(71) Applicant: Alden David Meier, Mt. Juliet, TN (US)

(72) Inventor: Alden David Meier, Mt. Juliet, TN (US)

(21) Appl. No.: 17/828,664

(22) Filed: May 31, 2022

Related U.S. Application Data
(60) Provisional application No. 63/195,090, filed on May 31, 2021.

(51) Int. Cl. F02K 7/06; F23C 15/00; F23R 7/00

(52) U.S. Cl. CPC F02K 7/06; F23C 15/00; F23R 7/00

(57) ABSTRACT

A device and assembly for reliably generating supersonic detonation waves in a fuel and air or fuel and oxygen mixture. The device uses a hemispherical detonation chamber into which reactants, consisting of a fuel and air or oxygen mixture are injected and ignited by a laser to initiate a detonation wave. The wave is reflected by the hemispherical geometry of the detonation chamber and exits the device through a fast-acting valve. The detonation chamber is then purged and the cycle is repeated many times per second. The device can be used for various applications which include but are not limited to a stand-alone intermittent combustion engine, a pre-detonator for an intermittent combustion engine, a projectile launcher, a cleaning device, acoustical energy generation, pressure energy generation, various manufacturing processes and electric power generation. The device may use liquid, gaseous, or solid fuels, depending on the application.

### CROSS-REFERENCE TO RELATED APPLICATIONS

This application claims the benefit of U.S. Provisional Application No. 63/195,090, filed May 31, 2021.

### STATEMENT REGARDING FEDERALLY SPONSORED RESEARCH

Not Applicable

### THE NAMES OF THE PARTIES TO A JOINT RESEARCH AGREEMENT

Not Applicable

### STATEMENT REGARDING PRIOR DISCLOSURES BY THE INVENTOR OR A JOINT INVENTOR

Not Applicable

### BACKGROUND OF THE INVENTION

### Field of the Invention

The present invention is in the field of combustion energy generation and, more specifically, pulse detonation combustion.

### Description of Related Art

The current approach for generating a pulse detonation wave in a Pulse Detonation Engine (PDE) or other device is to initiate deflagration in the main combustion tube itself or a pre-detonation chamber and then, by various means, transition the deflagration into a detonation wave in the main combustion tube. This is known as deflagration-to-detonation transition (DDT). This typically results in a relatively long combustion tube which is necessary in order to transition the deflagration wave to detonation and often requires additional turbulence generating techniques such as the Shchelkin spiral to accelerate and facilitate the transition from deflagration to detonation. Due to the relatively long combustion tube required in this approach, heating in the long tube becomes a major obstacle to a practical Pulse Detonation Engine (PDE) or Pulse Detonation Rocket Engine (PDRE). In addition, the long combustion tube reduces the operating frequency of the device. Another disadvantage of this approach is the inconsistency in reliably achieving detonation in the main chamber with some deflagrations failing to transition to detonation. This has a significant impact on the operation of the engine.

Techniques have been developed to implement a pre-detonator which initiates the deflagration prior to the main detonation in the combustion tube. These pre-detonators allow a smaller shock wave to be created which then initiates detonation in the main combustion tube but the current approaches also suffer from failures to transition from deflagration to detonation.

All of the prior art has mainly been focused on improving the transition time and the reliability of the deflagration-to-detonation transition. This has resulted in many different techniques to facilitate the transition including Shchelkin spirals, wire rings, orifice plates, center bodies or nozzles. While many of these techniques do accelerate the transition, they introduce complexity into the device, result in severe heating and reduce the operational reliability of the device.

The major challenges to achieve operational Pulse Detonation Propulsion systems are:
(a) The ability to rapidly and reliably initiate detonations using practical fuels
(b) Managing heat loads in long combustion tubes
(c) Operating at very high frequencies
(d) Minimizing weight, length and overall volume

### BRIEF SUMMARY OF THE INVENTION

An object of the present invention is to rapidly and reliably generate pulsed supersonic shock waves under a wide variety of conditions.

Another object of the present invention is to use a laser igniter to rapidly deliver a large amount of energy into the reactants to initiate detonation at a very precise location.

Another object of the present invention is to allow a variety of practical fuels and oxidizers to be used, depending on the application. The device may use liquid, gaseous, or solid fuels or a combination thereof, providing a wide range of options specifically tailored to the operational requirements.

Another object of the present invention is to provide a device that can operate at high frequencies.

Another object of the present invention is to minimize the volume and specifically, the length of the device.

Another objective of the present invention is to eliminate the need for turbulence generating techniques such as Shchelkin spirals to accelerate and facilitate the transition from deflagration to detonation.

The present invention achieves these objectives by reducing the size of the detonation wave generator into a device that is as small as possible using a hemispherical detonation chamber that reflects and concentrates the detonation wave. The device can be used as a stand-alone combustor, or as a pre-detonator for a larger combustor or as a pulse detonation generator for other uses. The primary application is for use in pulse detonation rocket engines or air-breathing pulse detonation engines but the device may also be used for any application that requires a supersonic detonation wave. For example the device can be used for various other applications not related to propulsion, including but not limited to electric power generation, a projectile launcher, a cleaning device for industrial equipment, acoustical energy generation, pressure energy generation and various manufacturing processes.

### BRIEF DESCRIPTION OF THE SEVERAL VIEWS OF THE DRAWINGS

Embodiments of the invention are described in the following drawings, wherein:

FIG. 1 shows a cross-sectional view of one embodiment of the pulse detonation wave generator.

FIG. 2 shows a top view of the embodiment of the pulse detonation wave generator depicted in FIG. 1.

FIG. 3 shows a cross sectional view of a valveless embodiment of the pulse detonation wave generator.

FIG. 4A shows the principle of operation where a detonation wave is initiated and propagates outward from the ignition origin

FIG. 4B shows the principle of operation where the detonation wave is reflected off the hemispherical detonation chamber and exits the chamber

FIG. 5 shows a schematic of the full detonation cycle

### DETAILED DESCRIPTION OF THE INVENTIION

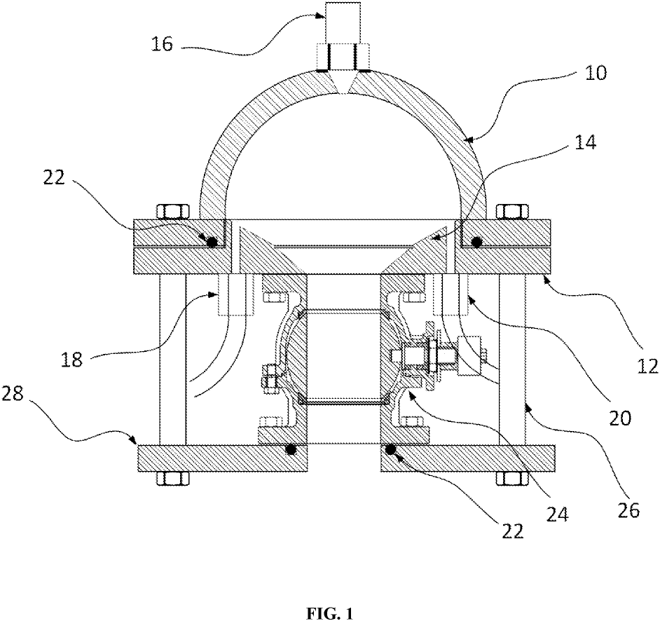

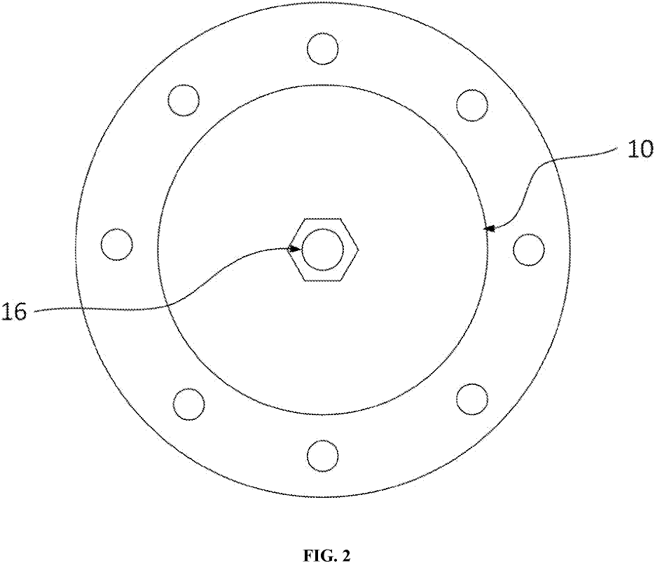

FIG. 1 shows a cross-sectional view of one embodiment of the pulse detonation wave generator according to the invention. The generator has one round, hemispherical detonation chamber 10. The bottom of the hemispherical detonation chamber 10 is closed off with a base plate 12 which has an exit aperature and which is attached to the hemispherical detonation chamber 10 with a flange and bolts. Alternatively, a v-band clamp can be used to connect the base plate 12 to the hemispherical detonation chamber 10. An O-ring 22 provides a gas seal between the hemispherical detonation chamber 10 and the base plate 12. In an alternate embodiment, a high temperature crush gasket, such as a mica gasket can be used to ensure a gas seal. Mica provides an effective seal at very high temperatures. A conical liner plate 14 is machined as part of the base plate 12 or affixed to the base plate 12 mechanically or welded to the base plate 12. FIG. 2 shows a top view of the round pulse detonation wave generator as depicted in FIG. 1.

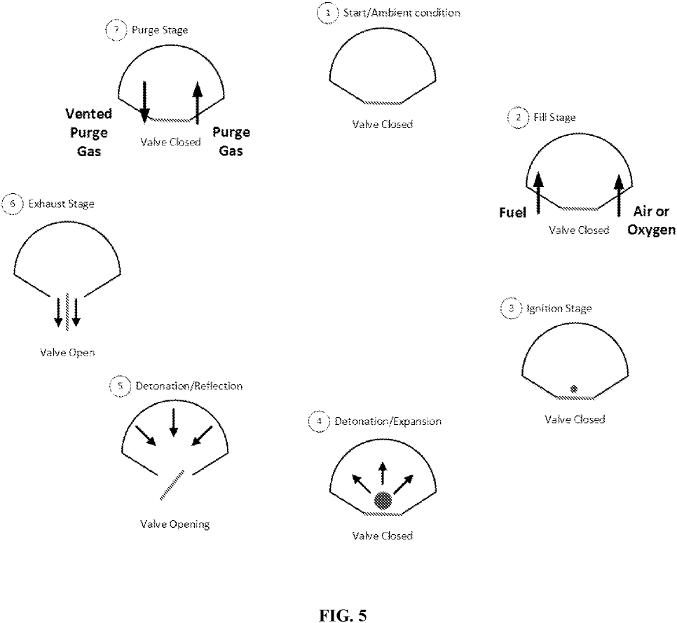

Below the base plate 12 is a chamber sealing valve 24 which seals the hemispherical detonation chamber 10 during filling, ignition, detonation, and purging operations. In the preferred embodiment, the hemispherical detonation chamber 10 is sealed by closing the chamber sealing valve 24. FIG. 5 shows a schematic of the full operational cycle.

In a preferred embodiment, the chamber sealing valve 24 is a fast-acting ¼ turn, 360 degree rotation ball valve that uses metal seats due to the high temperature gas travelling at supersonic speeds. The valve is driven by an actuator (not shown) which can be pneumatic, hydraulic or electrical solenoid activated, depending on the application. Other valve types are also possible for sealing the hemispherical detonation chamber 10. For example, rotary, flapper or electrically activated solenoid.

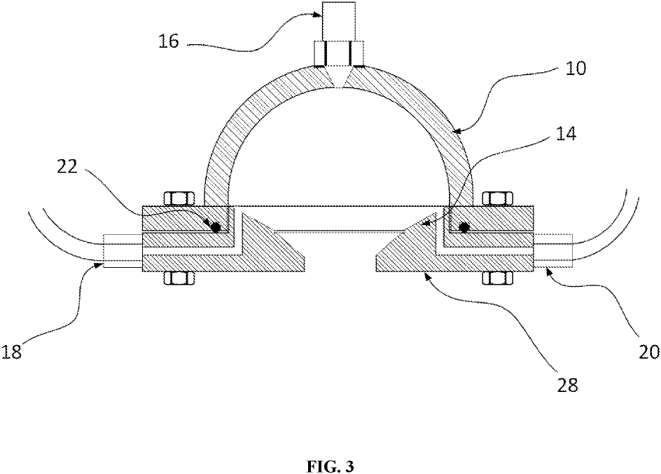

In an alternate embodiment, the hemispherical detonation chamber 10 is not mechanically sealed at all and the reactants are injected and ignited without mechanically sealing the hemispherical detonation chamber 10. In this embodiment, the injection sequence must be precisely controlled and timed to ensure reliable detonation of the reactants. FIG. 3 shows a cross-sectional view of a valveless embodiment.

In the preferred embodiment, performance optimization requires active computerized control of the detonation cycle which occurs at very high frequencies and over a wide range of conditions. For example, a practical Pulse Detonation Engine needs to operate between 50 to 100 Hz. A combination of sensors and one or more microprocessor controllers is required to monitor the entire operating sequence and control/optimize the critical functions such as fuel mixture ratio, ignition timing and valve opening and closing. The monitoring system must monitor and control key performance parameters such as detonation frequency, detonation pressure, temperature and fuel consumption, for example and make adjustments to ensure maximum performance. Those skilled in the art will recognize that the necessary control system is similar to those used in jet engines and liquid propellant rocket engines, for example.

The hemispherical detonation chamber 10 is filled with a mixture of fuel from a fuel injection manifold and air or oxygen from an air or oxygen injection manifold. The reactants are introduced into the hemispherical detonation chamber 10 through one or more fuel injectors 18 and one or more air or oxygen injectors 20. The injection of reactants is controlled by valves. At very high velocities for in-atmosphere vehicles, compressed air from an inlet air duct can be used and controlled by a valve.

For embodiments using liquid reactants, the hemispherical detonation chamber 10 will be supplied with the reactants through liquid fuel and/or liquid oxidizer lines and injectors.

In the preferred embodiment, the reactants are injected under pressure. Higher pressures are preferred in the hemispherical detonation chamber 10 since they produce higher velocity detonation waves.

The preferred embodiment for reactants is a gaseous, hydrogen/air or oxygen mixture due to its wide range of detonatable mixture ratios and the amount of energy released. However, many different fuels and fuel mixtures can be used by the device. These include, but are not limited to, methane, propane, acetylene, vaporized metals such as magnesium or aluminum, carbon based fuels and simple hydrocarbons that are highly atomized or vaporized. Stoichiometric mixtures are preferred since they produce higher velocity detonation waves.

In alternate embodiments, off-stoichiometric mixtures may be used depending on the reactants and their detonation characteristics or applications where reduced operating temperatures may be required.

The fuel used can be generated by a solid fuel gas generator to burn or pyrolize a solid fuel grain and generate a fuel rich gas mixture which is metered by a control valve into the hemispherical detonation chamber 10 through the fuel injector 18.

The oxidizer can also be generated by a solid fuel oxygen generator to create oxygen. This embodiment works by igniting a solid compound such as lithium perchlorate within a canister. The oxygen rich gas is then metered by a control valve into the hemispherical detonation chamber 10 through the air or oxygen injector 20.

Some embodiments can use a combination of fuels. For example, the device could use a solid fuel generator and a liquid oxidizer at launch where the airspeed is low and then transition to a liquid or gaseous fuel and air for sustained operation once sufficient velocity has been achieved.

For devices that operate within the earth’s atmosphere, the preferred embodiment uses air since it is readily available and because of its ability to support detonations with various fuels For devices that operate as a pulse detonation rocket engine, the choice of oxidizer can be a liquid oxidizer such as liquid oxygen, nitrous oxide or concentrated hydrogen peroxide, for example. In the preferred embodiment, the liquid oxidizer will be converted into a gas, vaporized, or highly atomized to promote rapid detonation.

It is to be understood that in some embodiments, the device illustrated in FIG. 1 can include additional elements. For example, the hemispherical detonation chamber 10 can include atomizer modules to atomize a liquid fuel, or liquid oxidizer prior to introduction into the combustor. Alternatively, the hemispherical detonation chamber 10 can include vaporizer modules to vaporize a liquid fuel or liquid oxidizer.

In the preferred embodiment, the fuel and air/oxygen reactants are injected with a specific amount of turbulence to achieve rapid and thorough mixing of the reactants. The turbulence can be created with a turbulence generator such as a perforated disk or a swirler in the injection ports.

This turbulence facilitates the rapid mixing of the reactants and provides for optimal detonation characteristics.

The injected reactants are then ignited by a laser igniter 16 which, in the preferred embodiment is a passively Q-switched laser but may be another type of laser aimed at the geometric center of the hemisphere which ignites the mixture, producing a symmetrical detonation wave.

In order to reliably produce a well formed spherical detonation wave, a large amount of energy must be released very rapidly into the reactants and the initiation point must be located precisely to produce a symmetrical detonation wave.

In the preferred embodiment, a passively Q-switched laser igniter 16 provides the necessary energy for rapid, reliable ignition within several hundred nanoseconds and provides the ability to precisely position the ignition at the geometric center of the hemisphere necessary for generating perfectly symmetrical shock waves. Those skilled in the art will recognize that other types of high energy igniters can also be utilized by the device.

The passively Q-switched laser igniter 16 generates a very high temperature light-emitting plasma which, when it cools down emits a pressure wave that propagates at supersonic speeds and ignites the fuel/air or oxygen mixture around the plasma core. This ensures a rapid and reliable detonation wave to be generated for each cycle of the device.

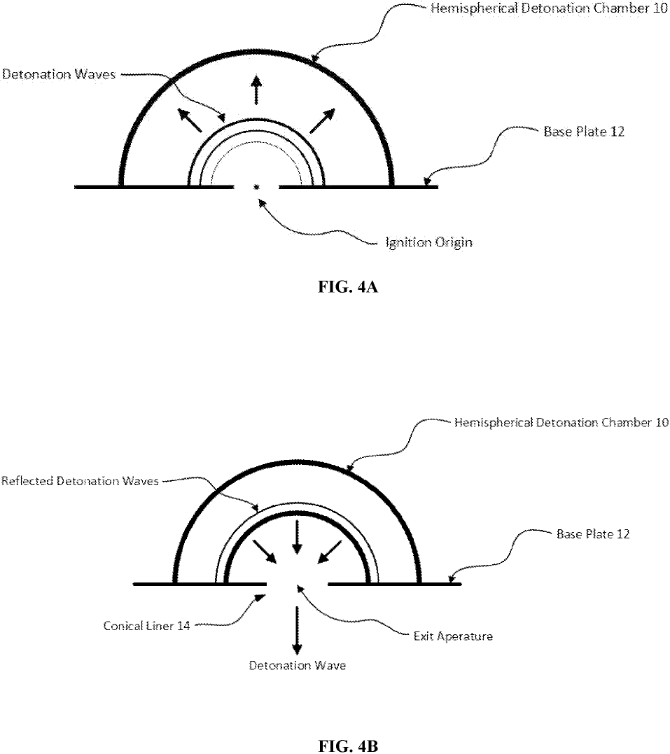

The resulting detonation wave then expands and impacts the wall of the hemispherical detonation chamber 10 causing the detonation wave to be reflected towards the conical liner plate 14 and the exit aperture in the base plate 12. See FIG. 4A and FIG. 4B for a schematic illustrating the principle of operation.

The conical liner plate 14 focuses the supersonic detonation wave and prevents extreme off-center shock waves which could damage the device. In one embodiment, the conical liner plate 14 is a separate component and is welded or mechanically attached to the base plate. In another embodiment, the conical liner plate 14 is machined as part of the base plate 12.

The conical liner plate 14 is tapered at an angle to optimize and focus the shock wave as it leaves the hemispherical detonation chamber 10, the conical liner plate 14 and base plate 12 entrance geometry are tapered to achieve the optimum shock wave for the fuel and air or oxygen mixture being used. In different embodiments, the angle of the conical liner plate angle 14 may vary with different fuel/air or oxygen combinations and/or pressures.

Once the detonation wave is initiated, the chamber sealing valve 24 is opened rapidly, allowing the fully formed detonation wave to exit the hemispherical detonation chamber 10. In the preferred embodiment, the timing of the opening and closing of the chamber sealing valve 24 is very important and must be computer controlled to precisely open and close at the exact moment. One or more sensors within the hemispherical detonation chamber 10 can be used to detect when the chamber sealing valve 24 is to be opened and closed. In an alternate embodiment, the opening of the chamber sealing valve 24 is controlled based on a timed offset of the laser firing to ignite the reactants. A combination of sensors and timing may also be implemented to control the device.

In an alternative embodiment where no chamber sealing valve 24 is present, the sensors simply control the injection of reactants, ignition and purge functions.

The chamber sealing valve 24 is attached to the attachment plate 28 mechanically with bolts and an O-ring 22 provides a gas seal between the sealing valve 24 and the attachment plate 28. In an alternate embodiment, a high temperature crush gasket, such as a mica gasket can be used to ensure a tight seal.

Due to the high temperatures resulting from the pulsed detonations, cooling of the device is required for sustained operation. Both gaseous and/or liquid coolants can be used. In one embodiment, a cooling jacket (not shown) surrounds the hemispherical detonation chamber 10 and the base plate 12 and any other areas of the device with high heat loads in order to provide active cooling to the device during operation due to the high operating temperature of the device.

In some embodiments, cooling channels may be machined into individual components allowing cooling passages in areas that cannot be protected by the cooling jacket.

In another embodiment, a cooling tube carrying coolant may also be wrapped around components that require cooling.

In another embodiment, a combination of cooling jackets, cooling channels and/or cooling tubes may be incorporated allowing optimal cooling for each component.

The cooling medium used by the device can be a liquid or gas or a combination thereof, depending upon the application.

In the preferred embodiment, the coolant is optimally the fuel used in the hemispherical detonation chamber 10. In this embodiment, preheating the fuel prior to being injected into the hemispherical detonation chamber 10 results in greater fuel efficiency since the fuel temperature is raised prior to injection.

For very low duration or single use embodiments, no cooling may be required since the life span of the device is limited to seconds or less and the operation of the device will not exceed the ability of the materials selected to withstand the high pressures and temperatures generated. In this embodiment, a high temperature resistant alloy or other material may be used or a combination of active and passive cooling may be used where required by the application.

In the preferred embodiment, after each detonation in the hemispherical detonation chamber 10, the hemispherical detonation chamber 10 is purged of combustion products in preparation for the next detonation to prevent premature ignition of the injected reactants and to ensure only pure, unburned reactants fill the chamber.

For air-breathing embodiments where compressed air is available, such as Pulse Detonation Engines (PDE), the hemispherical detonation chamber 10 can be purged after by introducing purge air through an air inlet and exhausted through an exhaust port. The introduction and exhausting of the purge medium is controlled by solenoid valves. In another embodiment, purge air is available from the compressor section of a turbine.

For non-air breathing embodiments such as Pulse Detonation Rocket Engines (PDRE), the chamber can be purged after by introducing purge fuel or oxidizer through a purge inlet and exhausted through an exhaust port. The introduction and exhausting of the purge medium is controlled by solenoid valves.

Materials of construction for the device must be selected based on extreme operating conditions. Components of the device will be required to operate at very high temperatures and intermittent peak pressures on the order of at least 20 to 40 atmospheres and in some cases, much higher.

The hemispherical detonation chamber 10, conical liner plate 14, base plate 12, chamber sealing valve 24 and other parts of the device can be constructed of aerospace grade high strength alloys such as hastelloy, inconel, titanium, or other alloys such as titanium-zirconium-molybdenum.

The hemispherical detonation chamber 10, conical liner plate 14, base plate 12, and other parts of the device can be constructed of composite materials such as machined carbon/carbon. Where composite materials are used for the hemispherical detonation chamber 10 or any other components subject to detonation gases, a coating of a suitable material must be applied to the surface of the carbon/carbon matrix to protect it from the high heat and detonation pressures generated within the device as well as the intermittent cycling.

It will be appreciated by those skilled in the art that ongoing development of new alloys and materials will undoubtedly produce new materials that will be suitable as well.

The components for the device can be manufactured using additive manufacturing, such as 3D printing or more traditional subtractive manufacturing techniques such as CNC machining, for example. This flexibility gives the designer considerable options when incorporating complex components such as cooling channels into the device.

The present invention has many uses due to its compact size and its ability to reliably and consistently generate pulse detonation waves. The device is designed to allow different attachments can be mated to the device, depending on the application. The attachments are connected to the device by an attachment plate 28 that is attached to the device through spacers 26 that align the attachment to the device and transfer loads between the components.

The device can be used as a single pulse detonation wave generator or in conjunction with multiple pulse detonation wave generators.

An embodiment is as a pre-detonator for a main combustion tube for air breathing pulse detonation engines (PDE’s) or for pulse detonation rocket engines (PDRE’s).

Another embodiment is as a stand-alone intermittent combustor with a DeLaval nozzle attachment for use as a thruster.

Another embodiment is a nozzle attachment for industrial cleaning or descaling hard to clean surfaces using the detonation wave energy.

Another embodiment is a sonic barrel attachment for an acoustical energy device such as a sound cannon.

Another embodiment is a barrel attachment for launching a projectile as a single shot device or a barrel and projectile feed mechanism attachment for multi-shot devices.

Another embodiment is a turbine attachment for generating electrical power. The hot gases, from the combustion chamber are expelled through a nozzle where they turn a turbine, which is used to generate electricity.

While the invention has been described in terms of various specific embodiments, those skilled in the art will recognize that the invention can be implemented with modification within the spirit and scope of the claims.

The Pulse Detonation Generator cycle is a sequence of distinct events in the preferred embodiment:
A. The hemispherical detonation chamber (10) is sealed by closing the chamber sealing valve (24). The chamber is at ambient conditions;
B. The hemispherical detonation chamber (10) is filled with a fuel and air or oxygen mixture in the appropriate ratio for the reactants and with the appropriate turbulence;
C. The laser igniter (16) fires and detonates the fuel/air or oxygen mixture;
D. The detonation wave expands until it impacts the hemispherical detonation chamber 10 walls.
E. The detonation wave is reflected back towards the hemispherical detonation chamber 10 exit. The chamber sealing valve (24) is opened before the detonation wave reaches the exit aperture;
F. The detonation wave exits the hemispherical detonation chamber (10) and the burned gases are exhausted;
G. The chamber sealing valve (24) is closed and the hemispherical detonation chamber 10 is purged, depending on the application; and the cycle is repeated.

What is claimed is:

1. A device for focusing detonation wave generated by the detonation of some predetermined ignitable mixture, said device comprising:
A hemispherically-shaped detonation chamber said chamber interior configured to contain a mixture and further to reflect and focus wave resulting from detonation of said mixture.

2. The device of claim 1 further including a cooling jacket to cool components subjected to heating by the detonations.
The device of claim 2 using a cooling channel to cool components heated by detonation.
The device of claim 2 wherein at least some components are uncooled, depending on the application, the materials of construction and the duration of continuous operation.

3. The device of claim 1 further including a laser igniter or similar device that generates sufficient energy to detonate the fuel at the geometric center of the chamber allowing a symmetrical shock wave to be produced.

4. The device of claim 1 further including a fast acting valve that seals the hemispherically-shaped detonation chamber, allowing pressurized fuel to be injected in said chamber prior to ignition and then rapidly unsealing said chamber when a detonation wave is generated.

5. The device of claim 1 further including at least one fuel injector that injects fuel into the interior of said hemispherically-shaped detonation chamber.

6. The device of claim 1 further including one or more injectors that inject air or oxygen into said hemispherically shaped detonation chamber.

7. The device of claim 1 further including turbulence generators within the injectors that create turbulence in the fuel and air/oxygen to facilitate rapid mixing and detonation
The device of claim 1 using swirl generators within the injectors that create a swirl in the fuel and air/oxygen to facilitate rapid mixing and detonation.

8. The device of claim 1 further including a conical liner plate which focuses the detonation wave as it leaves the hemispherically-shaped detonation chamber.

9. The device of claim 1 further including a base plate which encloses the hemispherically shaped detonation chamber and allows the detonation wave to exit said chamber.
